(19) United States
(12) Patent Application Publication
(10) Pub. No.: US 2006/0248823 A1
(43) Pub. Date: Nov. 9, 2006

(54) Window subassembly for use with insulated concrete forms

(76) Inventors: Stephen R. Bollinger, Chesterfield, MO (US); Steven R. Bowman, Glen Carbon, IL (US)

Correspondence Address: GREENSFELDER HEMKER & GALE PC, SUITE 2000, 10 SOUTH BROADWAY, ST LOUIS, MO, 63102, US

(21) Appl. No.: 11/370,614

(22) Filed: Mar. 8, 2006

Related U.S. Application Data
(60) Provisional application No. 60/678,069, filed on May 5, 2005.

(51) Int. Cl. E06B 3/00

(52) U.S. Cl. 52/204.5

(57) ABSTRACT

A window subassembly for installation with insulated concrete forms is disclosed. The window subassembly comprises opposing side panels secured to top and bottom panels that collectively define an interior boundary adapted to receive a window. The bottom panel includes a slope member that functions as a window sill to divert rain flow away from the window. In another embodiment, the window subassembly further comprises an air conditioning sub-assembly adapted to engage an air conditioning unit.

### CROSS-REFERENCE TO RELATED APPLICATION

This application claims the benefit of U.S. Provisional Patent Application Ser. No. 60/678,069, filed May 5, 2005, which is herein incorporated by reference.

### FIELD OF THE INVENTION

The present document relates to a window buck system for use with insulated concrete forms.

### SUMMARY

In an embodiment, the window subassembly may comprise a top panel and a bottom panel secured to opposing first and second side panels that collectively define an interior boundary, the top panel and the opposing first and second side panels each defining opposing exterior side members and first and second interior side members in a transverse aspect, the first and second interior side members defining an interior channel interposed between first and second slots.

In another embodiment, the window subassembly may comprise a top panel and a bottom panel secured to opposing first and second side panels that collectively define an interior boundary, the top panel and the opposing first and second side panels each having opposing exterior side members and first and second interior side members in a transverse aspect, the first and second interior side members defining an interior channel interposed between first and second slots, and an air conditioning inner-assembly, the air conditioning inner-assembly being positioned between the opposing first and second side panels with the air conditioning inner-assembly defining a second interior boundary.

In yet another embodiment, a method of installing a window may comprise:

a) securing a plurality of insulated concrete forms comprising structural elements that define a space between the structural elements and an opening defined by the plurality of insulated concrete forms;

b) installing a window subassembly into the opening defined by the plurality of concrete forms, the window subassembly comprising top and bottom panels secured to opposing first and second side panels that collectively define an interior boundary, the top panel and opposing first and second side panels each including opposing exterior side members and first and second interior side members in a transverse aspect, the first and second interior side members defining an interior channel interposed between first and second slots;

c) pouring a fluid concrete in the space defined between the structural elements;

d) allowing the fluid concrete to cure; and

e) securing a window to the window subassembly.

In yet another embodiment, a method of installing a window and an air conditioning unit may comprise:

a) securing a plurality of insulated concrete forms comprising structural elements that define a space between the structural elements and an opening defined by the plurality of insulated concrete forms;

b) installing a window subassembly into the opening defined by the plurality of concrete forms, the window subassembly comprising top and bottom panels secured to opposing first and second side panels that collectively define an interior boundary, the top panel and opposing side panels each define opposing exterior side members and first and second interior side members in a transverse aspect, the first and second interior side members defining an interior channel interposed between first and second slots, and an air conditioning inner-assembly positioned between said opposing first and second side panels with the air conditioning inner-assembly defines a second interior boundary;

c) pouring a fluid concrete in the space defined between the structural elements; and

d) allowing the fluid concrete to cure; and

e) installing a window in the interior boundary and an air conditioning unit in the second interior boundary.

Implementation of the above embodiments may include one or more of the following features:

The top panel and the opposing first and second side panels each further include a back member in communication with the interior channel and the first and second slots.

The back member communicates with a shoulder member with shoulder member defining a shoulder.

Each of the first and second interior members define an inwardly extending flange.

The inwardly extending flanges partially define the interior channel.

The bottom panel includes a flat portion in communication with a slope member and a shoulder member with the shoulder member defining a shoulder.

The slope member includes a slope portion with the slope portion being defined at an angle relative to the flat portion.

The shoulder member is adapted to engage a mounting member.

The interior boundary is adapted to receive at least one temporary support member for providing structural support to the top panel and the bottom panel secured to opposing first and second side panels.

The top panel, bottom panel and opposing first and second side panels include a plurality of screw blocks with each of the plurality of screw blocks being adapted to receive a respective screw attachment.

The air conditioning inner-assembly comprises opposing first and second side portions engaged between a bottom portion and the bottom panel.

The air conditioning inner-assembly further comprises a lateral portion engaged between the opposing first and second side portions.

The bottom portion defines a rear member having opposing first and second side portions that collectively define an interior channel.

The step of securing the window to the window subassembly further comprises providing a mounting member.

The method of installing further comprises providing a temporary support member inside the interior boundary prior to pouring the fluid concrete in the space.

The temporary support member is removed from the interior boundary after the fluid concrete is allowed to cure.

The step of pouring fluid concrete in the space defined between the structural elements permits the fluid concrete to fill the interior channel of the top panel and the opposing first and second side panels.

The step of installing the window subassembly into the opening defined by the concrete forms further includes engaging the structural elements to the first and second slots, respectively.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a perspective view of one embodiment of the window subassembly;

FIG. 2 is a perspective view of an alternative embodiment of the window subassembly;

FIG. 3 is a cross-sectional view of the top panel of the window subassembly taken along line 3-3 of FIG. 2;

FIG. 4 is a cross-sectional view of the bottom panel of the window subassembly taken along line 4-4 of FIG. 2;

FIG. 5 is a cross-sectional view of the bottom portion of the window subassembly taken along line 5-5 of FIG. 1;

FIG. 6 is a perspective view of the alternative embodiment of the window subassembly installed in an opening defined by an assembly of insulated concrete forms; and

FIG. 7 is an enlarged partial cross-sectional view of the top panel taken along line 7-7 of FIG. 6 illustrating the engagement of the window subassembly to the insulated concrete form and the window.

Corresponding reference characters indicate corresponding elements among the view of the drawings.

### DETAILED DESCRIPTION

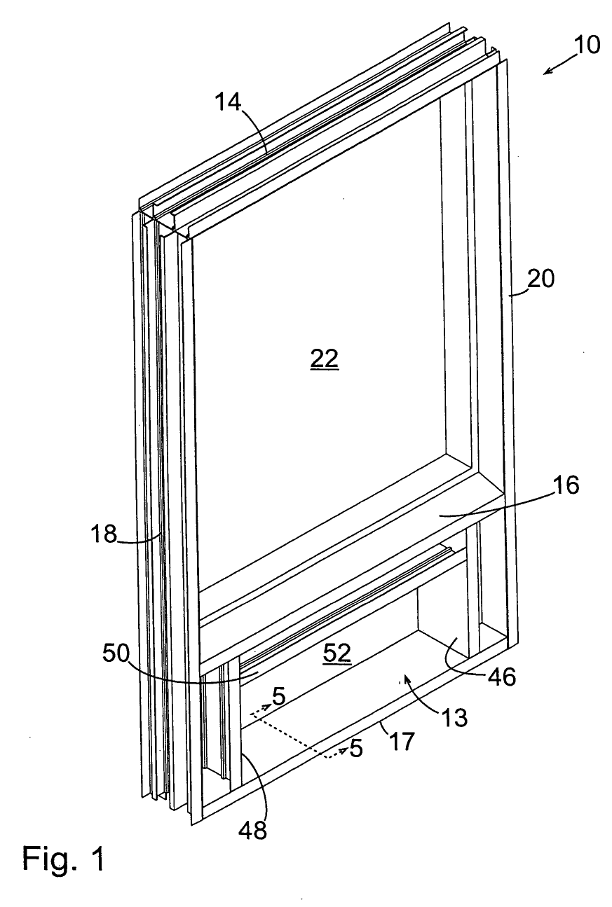

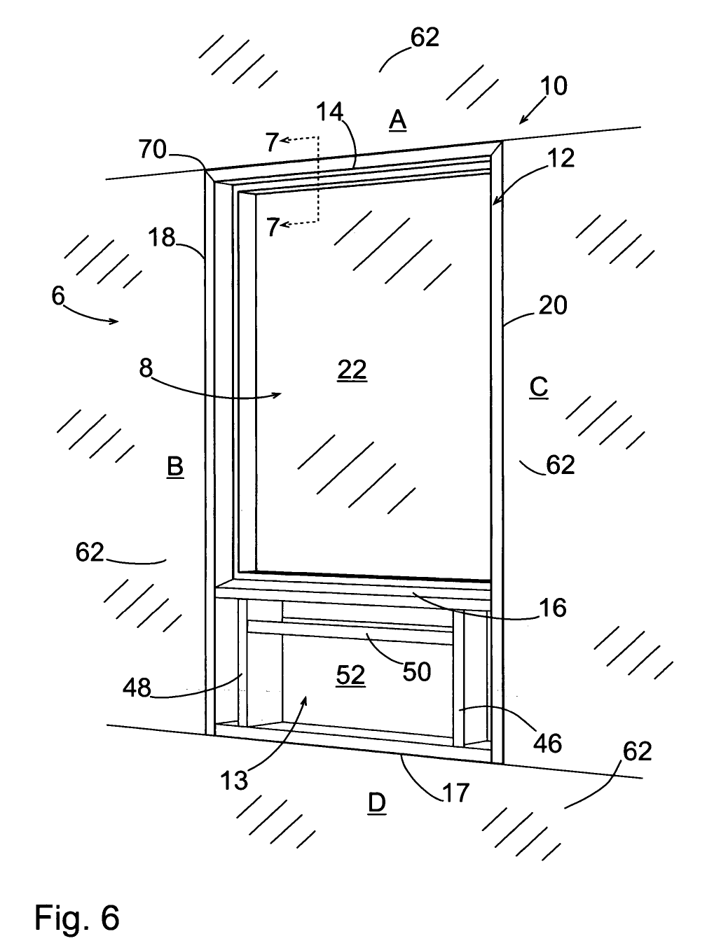

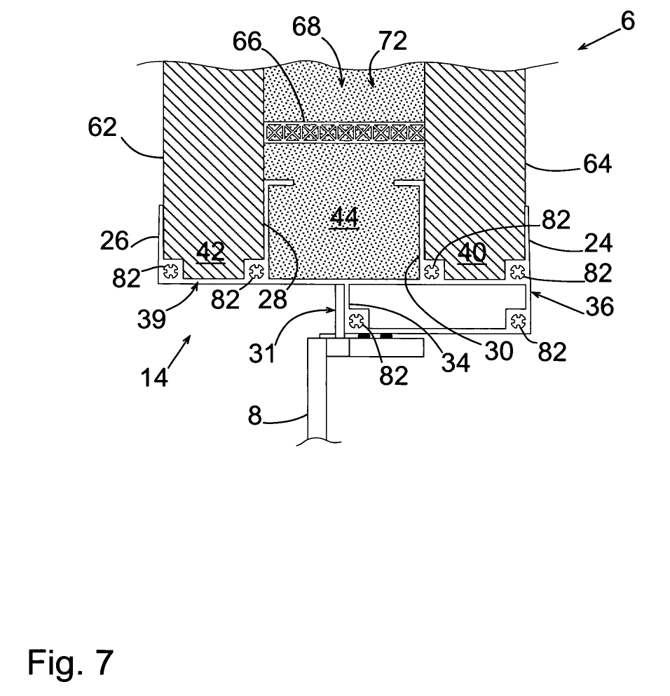

Referring to the drawings, a window subassembly is illustrated and generally indicated as 10 in FIGS. 1-7. In one embodiment, window subassembly 10 may be constructed out of extruded vinyl shapes and assembled as necessary with screw attachments (not shown). The screw attachments may be adapted to engage screw blocks 82 positioned in various locations on each extrusion and formed as an integral part of the extrusion as shall be discussed below. As shown in FIG. 6, the window subassembly 10 may be adapted to engage a plurality of insulated concrete forms 6, designated A, B, C and D for installation of a window 8 (FIG. 7) and an air conditioning unit (not shown) when constructing a concrete wall 7.

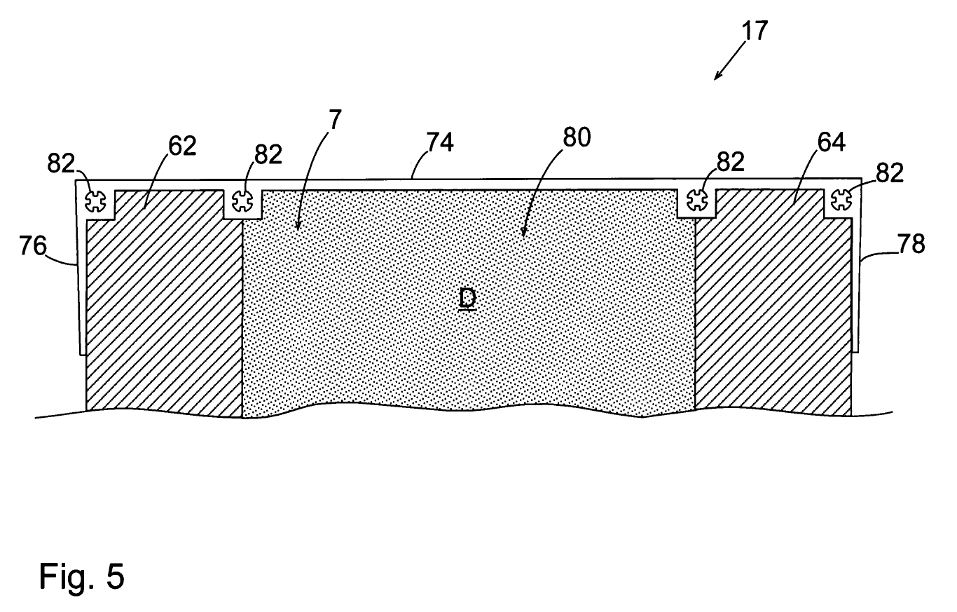

Referring to FIG. 7, each insulated concrete form 6 may include an exterior panel 62 connected to an interior panel 64 by a plurality of lateral securing members 66 spaced along the length of the insulated concrete form 6 and a space 68 defined between the exterior panel 62 and interior panel 64. The space 68 may be adapted to receive fluid concrete 72 that cures and forms a solid concrete wall 7 (FIG. 5) between panels 62 and 64. In one embodiment, each panel 62 and 64 may be made from a lightweight material adapted for use with fluid concrete 72, such as Styrofoam or like material.

When constructing concrete wall 7, in one embodiment the insulated concrete forms 6 may be assembled to define an opening 70 (FIG. 6) such that the window subassembly 10 is installed therein before fluid concrete 72 is poured into space 68. Once space 68 is full of concrete 72, the concrete 72 is allowed to cure around the periphery of the window subassembly 10 such that a secure bond is provided between the insulated concrete forms 6 and the window subassembly 10.

In one embodiment shown in FIG. 1, the window subassembly 10 may comprise a body 12 having opposing first and second side panels 18 and 20 secured to opposing top and bottom panels 14 and 16 that collectively define an interior boundary 22 adapted to receive window 8 during installation with window subassembly 10. Window subassembly 10 may further include an air conditioning inner-assembly 13 positioned between opposing side panels 18, 20. The air condition inner-assembly 13 may include opposing first and second side portions 46 and 48 engaged between the bottom panel 16 and bottom portion 17 with a lateral portion 50 engaged between the first and second side portions 46 and 48 that collectively define a second interior boundary 52 adapted to receive a conventional air conditioning unit (not shown) during installation.

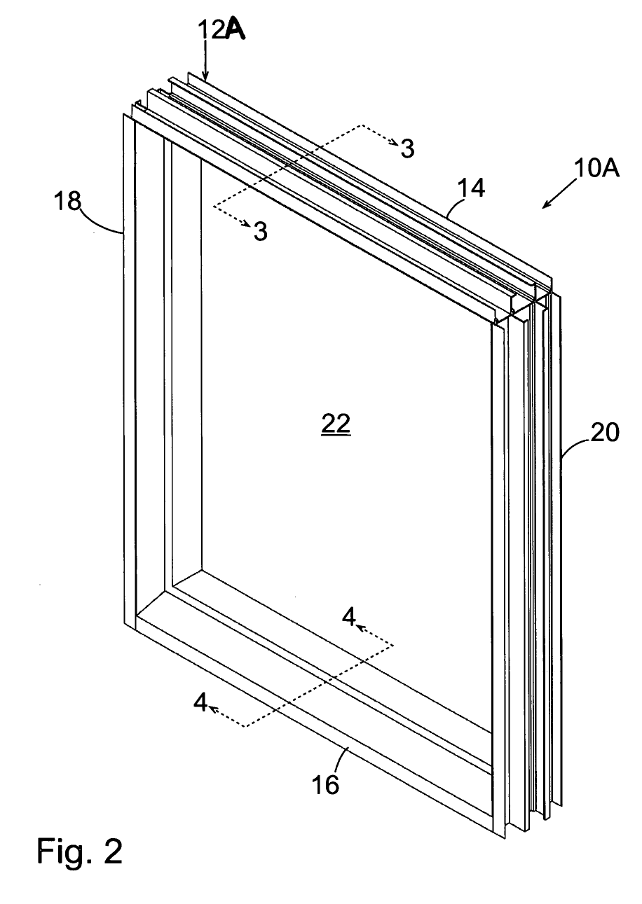

Referring to FIG. 2, another embodiment of the window subassembly designated 10A is illustrated. Window subassembly 10A may be substantially similar to window subassembly 10 of the other embodiment, but lack the structural elements related to the air conditioning inner-assembly 13 such that window subassembly 10A is used for installation of window 8 only. As shown, window subassembly 10A may comprise a body 12A having opposing first and second side panels 18 and 20 configured similarly to those of window subassembly 10 which are secured to opposing top and bottom panels 14 and 16 that define an interior boundary 22 adapted to receive window 8.

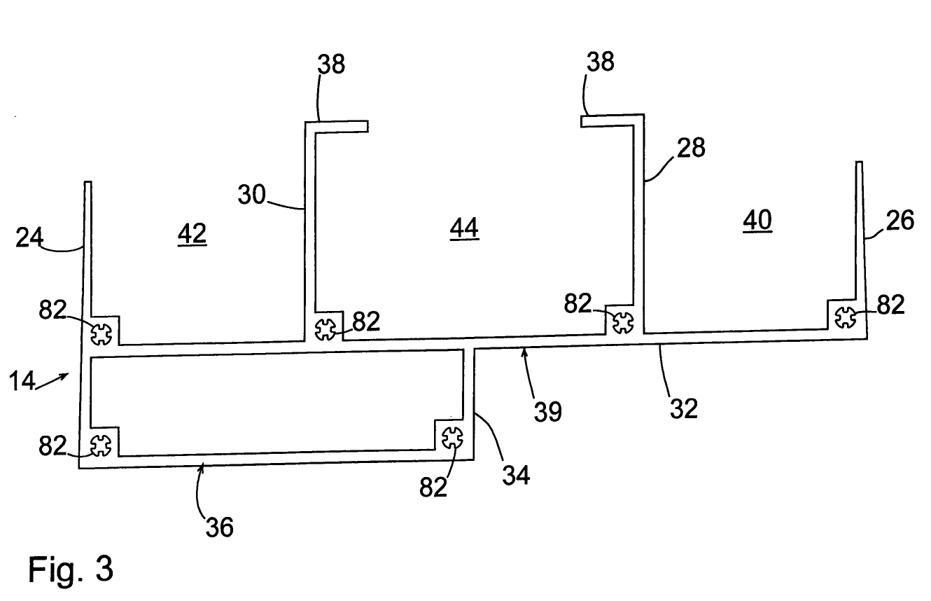

Referring to FIG. 3, top panel 14 (FIG. 2) may comprise a shoulder member 36 defining a shoulder 34 and a member 39 adapted to engage the exterior and interior panels 62 and 64 of insulated concrete forms 6 and form opening 68 as depicted in FIG. 7 as shall be discussed in greater detail below. The member 39 may include a back member 32 having perpendicular opposite exterior side members 24, 26 defined outside parallel interior side members 28, 30 extending outwardly from back member 32 that define an interior channel 44 interposed between first and second slots 40 and 42.

As shown, first and second slots 40 and 42 may be sized and shaped to engage the interior panel 62 and exterior panel 64, respectively, of each insulated concrete form A, B and C as illustrated in FIG. 7. The opposing first and second side panels 18 and 20 may have identical cross-sections as top panel 14; however, for purposes of illustration and discussion, only the top panel 14 is described herein. In addition, the panels 14, 16, 18 and 20 of window subassembly 1OA may be similar in structure to panels 14, 16, 18 and 20, respectively, of window subassembly 10.

As further shown, each interior side member 28, 30 may define an inwardly extending flange 38 that partially defines interior channel 44 for providing a means of receiving and retaining the concrete 72. The back member 32 of the top panel 14, bottom panel 16 and opposing side panels 18, 20 may be adapted to retain the fluid concrete 72 outside the interior boundary 22 when the concrete 72 is poured into space 68 of each insulated concrete form A, B and C during construction of concrete wall 7.

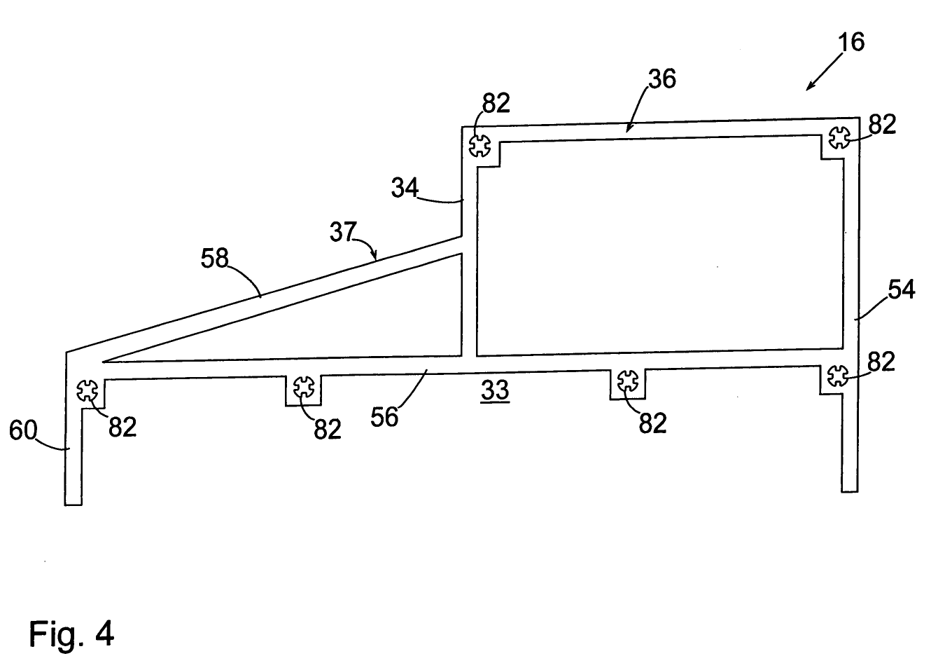

Referring to FIG. 4, bottom panel 16 may include a flat portion 56 interposed between exterior portion 54 and interior portion 60 in communication with a slope member 37 and a shoulder member 35. The bottom panel 16 may act as a sill for window 8 with the shoulder member 35 defining a shoulder 34 adapted to engage window 8 during installation by mounting member 31 (FIG. 7). The slope member 37 may further include a slope portion 58 defined at an angle relative to the flat portion 56 for diverting rain water away from window 8. The interior portions 54, 60 collectively define an interior channel 33 adapted to engage insulated concrete panel D when window subassembly 10 is installed. As noted above, the slope portion 58 functions as a window sill and is set at an angle sufficient to divert rain flow away from the window 8 after installation.

A method of installing window subassembly 10 with an assembly of insulated concrete forms 6 is contemplated. Window subassembly 10 may be assembled on site using screws attachments (not shown) that secure the opposing side panels 18 and 20 to the top panel 14 and bottom portion 17 through the plurality of screw blocks 82 formed through each panel 14, 16, 18 and 20. In one embodiment, the air conditioning inner-assembly 13 may be assembled and secured between the lateral portion 50 and bottom portion 17 in a similar manner.

Referring to FIG. 5, insulated concrete form D may be first filled with fluid concrete 72 that is allowed to set and cure to form a base portion of concrete wall 7. The bottom portion 17 may define a rear member 74 having opposing first and second side portions 76, 78 that collectively define an interior channel 80. In assembly, the bottom portion 17 of window subassembly may be engaged to insulated concrete form D by engaging the interior surface of opposing first and second side portions 76 and 78 to the exterior surfaces of exterior panel 62 and interior panel 64, respectively, of the insulated concrete form D.

This procedure may be repeated for engaging the top and side panels 14, 18 and 20 to the other insulated concrete forms A, B and C wherein the exterior side members 24 and 26 of top panel 14 and side panels 18, 20 are each engaged to the exterior and interior panels 62 and 64 of insulated concrete forms A, B, C, respectively.

In one embodiment, a temporary support member (not shown), for example at least one piece of wood, may be sized and shaped to be inserted between the top and bottom panels 14 and 16 and/or opposing side panels 18 and 20 after assembly of panels 14, 16, 18 and 20 as discussed above. The temporary support member provides a means for structurally reinforcing window subassembly 10 during the stage when the fluid concrete 72 is poured into the space 68 of insulated concrete forms A, B and C that surround window subassembly 10 to prevent the window subassembly from collapsing. The temporary support member may also be an inexpensive means of structurally reinforcing the window subassembly 10 when fluid concrete is being poured without having to secure a plurality of connectors when assembling window subassembly 10.

After the fluid concrete 72 is allowed to cure a strong structural bond between the cured concrete 72 and the panels 14, 18 and 20 is established which permits the removal of the temporary support member from the window subassembly 10. Finally, the window 8 may be installed against the shoulder 34 defined by panels 14, 16, 18 and 20 as a mounting surface using mounting member 31 (FIG. 7), while air conditioning unit is installed into the air conditioning sub-assembly 13 using methods known in the art to properly position and engage the air condition unit therein.

Similar to the above method, window subassembly 10A may be prefabricated and assembled off site by securing panels 14, 16, 18 and 20, together in the same manner as described above and supporting the window subassembly 10A with a temporary support member. The window subassembly 10A may then be engaged to opening 70 defined by the constructed insulated concrete forms A, B, C and D and fluid concrete poured into the space 68. In either embodiment, the temporary supporting member may be removed once the concrete 72 is allowed to cure.

It should be understood from the foregoing that, while particular embodiments have been illustrated and described, various modifications can be made thereto without departing from the spirit and scope of the invention as will be apparent to those skilled in the art. Such changes and modifications are within the scope and teaching of this invention as defined in the claims appended hereto.

1. A window subassembly comprising:
a top panel and a bottom panel secured to opposing first and second side panels that collectively define an interior boundary, said top panel and said opposing first and second side panels each defining opposing exterior side members and first and second interior side members in a transverse aspect, said first and second interior side members defining an interior channel interposed between first and second slots.

2. The window subassembly according to claim 1, wherein said top panel and said opposing first and second side panels each further include a back member in communication with said interior channel and said first and second slots.

3. The window subassembly according to claim 2, wherein said back member communicates with a shoulder member, said shoulder member defining a shoulder.

4. The window subassembly according to claim 1, wherein each of said first and second interior members define an inwardly extending flange.

5. The window subassembly according to claim 4, wherein said inwardly extending flanges partially define said interior channel.

6. The window subassembly according to claim 1, wherein said bottom panel includes a flat portion in communication with a slope member and a shoulder member, said shoulder member defining a shoulder.

7. The window subassembly according to claim 6, wherein said slope member includes a slope portion, said slope portion being defined at an angle relative to said flat portion.

8. The window subassembly according to claim 6, wherein said shoulder member is adapted to engage a mounting member.

9. The window subassembly according to claim 1, wherein said interior boundary is adapted to receive at least one temporary support member secured between said top panel and said bottom panel and/or secured between said opposing first and second side panels.

10. The window subassembly according to claim 1, wherein said top panel, bottom panel and opposing first and second side panels include a plurality of screw blocks, each of said plurality of screw blocks being adapted to receive a respective screw attachment.

11. A window subassembly comprising:
a top panel and a bottom panel secured to opposing first and second side panels that collectively define an interior boundary, said top panel and said opposing first and second side panels each having opposing exterior side members and first and second interior side members in a transverse aspect, said first and second interior side members defining an interior channel interposed between first and second slots, and
an air conditioning inner-assembly, said air conditioning inner-assembly being positioned between the opposing first and second side panels with said air conditioning inner-assembly defining a second interior boundary.

12. The window subassembly according to claim 11, wherein said top panel and said opposing first and second side panels each further include a back member in communication with said interior channel and said first and second slots.

13. The window subassembly according to claim 12, wherein said back member communicates with a shoulder member, said shoulder member defining a shoulder.

14. The window subassembly according to claim 11, wherein each of said first and second interior members define an inwardly extending flange.

15. The window subassembly according to claim 14, wherein said inwardly extending flanges partially define said interior channel.

16. The window subassembly according to claim 11, wherein said bottom panel includes a flat portion in communication with a slope member and a shoulder member, said shoulder member defining a shoulder.

17. The window subassembly according to claim 16, wherein said slope member includes a slope portion, said slope portion being defined at an angle relative to said flat portion.

18. The window subassembly according to claim 16, wherein said shoulder member is adapted to engage a mounting member for mounting a window to the window subassembly.

19. The window subassembly according to claim 11, wherein said interior boundary is adapted to receive at least one temporary support member secured between said top panel and said bottom panel and/or secured between said opposing first and second side panels.

20. The window subassembly according to claim 11, wherein said top panel, bottom panel and opposing first and second side panels include a plurality of screw blocks, each of said plurality of screw blocks being adapted to receive a respective screw attachment.

21. The window subassembly according to claim 11, wherein said air conditioning inner-assembly comprises opposing first and second side portions engaged between a bottom portion and said bottom panel.

22. The window subassembly according to claim 21, wherein said air conditioning inner-assembly further comprises a lateral portion engaged between said opposing first and second side portions.

23. The window subassembly according to claim 21, wherein said bottom portion defines a rear member having opposing first and second side portions that collectively define an interior channel.

24. A method of installing a window comprising the steps of:
a) securing a plurality of insulated concrete forms comprising structural elements that define a space between the structural elements and an opening defined by the plurality of insulated concrete forms;
b) installing a window subassembly into the opening defined by the plurality of concrete forms, the window subassembly comprising top and bottom panels secured to opposing first and second side panels that collectively define an interior boundary, the top panel and opposing first and second side panels each including opposing exterior side members and first and second interior side members, said first and second interior side members defining an interior channel interposed between first and second slots;
c) pouring a fluid concrete in the space defined between the structural elements;
d) allowing the fluid concrete to cure; and
e) securing a window to the window subassembly.

25. The method of installing a window according to claim 24, wherein said step of securing said window to the window subassembly further comprises providing a mounting member.

26. The method of installing a window according to claim 24, further comprising the step of providing a temporary support member inside said interior boundary prior to pouring said fluid concrete in said space.

27. The method of installing a window according to claim 26, wherein said temporary support member is removed from said interior boundary after said fluid concrete is allowed to cure.

28. The method of installing a window according to claim 24, wherein said step of pouring fluid concrete in the space defined between said structural elements permits said fluid concrete to fill said interior channel of said top panel and said opposing first and second side panels.

29. The method of installing a window according to claim 24, wherein said step of installing the window subassembly into the opening defined by said concrete forms further includes engaging said structural elements to said first and second slots, respectively.

30. A method of installing a window and an air conditioning unit comprising:
a) securing a plurality of insulated concrete forms comprising structural elements that define a space between the structural elements and an opening defined by the plurality of insulated concrete forms;
b) installing a window subassembly into the opening defined by the plurality of concrete forms, the window subassembly comprising top and bottom panels secured to opposing first and second side panels that collectively define an interior boundary, the top panel and opposing side panels each define opposing exterior side members and first and second interior side members that define an interior channel interposed between first and second slots, and an air conditioning inner-assembly positioned between said opposing first and second side panels with said air conditioning inner-assembly defines a second interior boundary;
c) pouring a fluid concrete in the space defined between the structural elements; and
d) allowing the fluid concrete to cure; and
e) installing a window in the interior boundary and an air conditioning unit in the second interior boundary.

31. The method of installing a window and an air conditioning unit according to claim 30, wherein said step of securing said window to the window subassembly further comprises providing a mounting member.

32. The method of installing a window and an air conditioning unit according to claim 30, further comprising providing a temporary support member inside said interior boundary prior to pouring said fluid concrete in said space.

33. The method of installing a window and an air conditioning unit according to claim 32, wherein said temporary support member is removed from said interior boundary after said fluid concrete is allowed to cure.

34. The method of installing a window according to claim 24, wherein said step of pouring fluid concrete in the space defined between said structural elements permits said fluid concrete to fill said interior channel of said top panel and said opposing first and second side panels.

35. The method of installing a window according to claim 24, wherein said step of installing the window subassembly into the opening defined by said concrete forms further includes engaging said structural elements to said first and second slots, respectively.
